(19) United States
(12) Patent Application Publication
(10) Pub. No.: US 2025/0188283 A1
(43) Pub. Date: Jun. 12, 2025

(54) ECO-FRIENDLY POLYPROPYLENE COMPOSITION AND VEHICLE INTERIOR MATERIAL CONTAINING THE SAME

(71) Applicants: Hyundai Motor Company, Seoul (KR); Kia Corporation, Seoul (KR); MIKA Inc., Seongnam-si (KR)

(72) Inventors: Dae Sik Kim, Yongin-si (KR); Mun Gyu Bak, Hwaseong-si (KR); Han Ki Lee, Seoul (KR); Jun Ho Lee, Yongin-si (KR); Jong Hyeon Kim, Seongnam-si (KR); Im Taek Sung, Asan-si (KR)

(21) Appl. No.: 18/437,831

(22) Filed: Feb. 9, 2024

(30) Foreign Application Priority Data
Dec. 7, 2023 (KR) 10-2023-0176161

(51) Int. Cl. C08L 99/00; C08K 7/14; C08L 23/12

(52) U.S. Cl. CPC C08L 99/00; C08K 7/14; C08L 23/12; C08K 2201/003; C08K 2201/004; C08L 2205/025; C08L 2205/035; C08L 2205/08

(57) ABSTRACT

An embodiment polypropylene composition includes a composite including wood flour and a low molecular weight hydrocarbon-based material, a highly crystalline polypropylene-based resin, a graft-modified polypropylene-based resin, and a fiber filler. In an embodiment, the composition includes 35 wt % to 45 wt % of the composite, 30 wt % to 40 wt % of the highly crystalline polypropylene-based resin, 1 wt % to 5 wt % of the graft-modified polypropylene-based resin, and 15 wt % to 25 wt % of the fiber filler.

### CROSS-REFERENCE TO RELATED APPLICATIONS

This application claims the benefit of Korean Patent Application No. 10-2023-0176161, filed on Dec. 7, 2023, which application is hereby incorporated herein by reference.

### TECHNICAL FIELD

The present disclosure relates to an eco-friendly polypropylene composition and a vehicle interior material including the same.

### BACKGROUND

Technologies related to carbon dioxide reduction to solve the global warming problem are being researched in all industrial fields, and the automobile sector is also focusing investment on related research. For example, there are conversion from an internal combustion engine to an electric drive motor, use of new and renewable energy, such as solar power and hydrogen, and application of eco-friendly materials, such as recycled materials and bio-materials.

Among eco-friendly materials, bio-plastics, such as polylactic acid formed of corn or polyethylene using sugar cane, have been commercialized and applied to vehicle parts and materials, but, due to low price competitiveness and limitations in mechanical properties, they are used after mixing with petroleum-based materials, and thus, there is a limitation of low biomass-based content.

Wood-related materials which are inexpensive and non-food resources are also being applied to increase biomass-based content, but, when wood-plastic composites are applied to vehicle interior materials and parts, there is a disadvantage that it is difficult to increase the content due to poor processability and properties.

The above information disclosed in this background section is only for enhancement of understanding of the background of embodiments of the invention, and therefore it may contain information that does not form the prior art that is already known to a person of ordinary skill in the art.

### SUMMARY

Embodiments of the present invention have been made in an effort to solve problems associated with the prior art, and an embodiment of the present invention provides an eco-friendly polypropylene composition which may secure compatibility and bonding strength even when applying wood components and wood flour and may realize properties related to vehicle interior materials.

Another embodiment of the present invention provides an eco-friendly polypropylene composition which minimizes strand breakage due to phase separation and has high production efficiency.

The embodiments of the present invention are not limited to the above-mentioned embodiments. The embodiments of the present invention will become clearer from the following description and may be realized by means stated in the claims and combinations thereof.

One embodiments of the present invention provides an eco-friendly polypropylene composition including a composite including wood flour and a low molecular weight hydrocarbon-based material, a highly crystalline polypropylene-based resin, a graft-modified polypropylene-based resin, and a fiber filler.

In a preferred embodiment, the eco-friendly polypropylene composition may include 35 wt % to 45 wt % of the composite, 30 wt % to 40 wt % of the highly crystalline polypropylene-based resin, 1 wt % to 5 wt % of the graft-modified polypropylene-based resin, and 15 wt % to 25 wt % of the fiber filler.

In another preferred embodiment, a content of the wood flour may be 60 wt % to 80 wt % with respect to 100 wt % of the composite.

In still another preferred embodiment, a weight-average molecular weight of the low molecular weight hydrocarbon-based material may be 500 or less.

In yet another preferred embodiment, the highly crystalline polypropylene-based resin may include a first polypropylene-based resin having an isotactic pentad fraction of 96% or more by 13C-NMR, and it may optionally include a second polypropylene-based resin including a propylene-ethylene copolymer.

In still yet another preferred embodiment, a content of the first polypropylene-based resin may be 20 wt % or more with respect to a total weight of the composition.

In a further preferred embodiment, a melt index of the first polypropylene-based resin may be 30 g/min to 70 g/min at a temperature of 230° C. and a load of 2.16 kg.

In another further preferred embodiment, the graft-modified polypropylene-based resin may be configured such that 1 mol % to 2 mol % thereof is graft-modified with a material selected from the group consisting of maleic anhydride, acrylic acid, methacrylic acid, and combinations thereof.

In still another further preferred embodiment, the fiber filler may have a length of 3 mm to 10 mm and an average diameter of 4 μm to 20 μm.

In yet another further preferred embodiment, the fiber filler may include a fiber selected from the group consisting of glass fiber, carbon fiber, metal oxide fiber, and combinations thereof.

In still yet another further preferred embodiment, the eco-friendly polypropylene composition may have tensile strength of 26 MPa or more according to ISO 725, a flexural modulus of 2450 MPa or more according to ISO 178, and an IZOD impact strength of 4.0 J/m or more according to ISO 180.

Another embodiment of the present invention provides a vehicle interior material including the eco-friendly polypropylene composition.

Other aspects of preferred embodiments of the invention are discussed infra.

The above and other features of embodiments of the invention are discussed infra.

### DETAILED DESCRIPTION OF ILLUSTRATIVE EMBODIMENTS

The above-described objects, other objects, advantages, and features of embodiments of the present invention will become apparent from the descriptions of embodiments given hereinbelow. However, the embodiments of the present invention are not limited to the embodiments disclosed herein and may be implemented in various different forms. The embodiments are provided to make the description of the embodiments of the present invention thorough and to fully convey the scope of the embodiments of the present invention to those skilled in the art.

In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the embodiments of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements, or parts stated in the description or combinations thereof, and they do not exclude the presence of one or more other characteristics, numbers, steps, operations, elements, parts, or combinations thereof, or the possibility of adding the same. In addition, it will be understood that when a part, such as a layer, a film, a region, or a plate, is said to be “on” another part, the part may be located “directly on” the other part or other parts may be interposed between the two parts. In the same manner, it will be understood that when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are obtained from essentially different things are reflected, and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

### Eco-Friendly Polypropylene Composition

An eco-friendly polypropylene composition according to one embodiment of the present invention may include a composite comprising wood flour and a low molecular weight hydrocarbon-based material, a highly crystalline polypropylene-based resin, a graft-modified polypropylene-based resin, and a fiber filler.

For example, the eco-friendly polypropylene composition may include 35 wt % to 50 wt % of the composite, 30 wt % to 40 wt % of the highly crystalline polypropylene-based resin, 1 wt % to 5 wt % of the graft-modified polypropylene-based resin, and 15 wt % to 25 wt % of the fiber filler.

When the weight of the composite is less than 35 wt %, the biomass content is insufficient and thus eco-friendliness may be reduced, and when the weight of the composite exceeds 50 wt %, it may be difficult to implement properties required for vehicle interior materials.

When the weight of the highly crystalline polypropylene-based resin is less than 30 wt %, there is a risk that formability and impact strength may be deteriorated, and when the weight of the highly crystalline polypropylene-based resin exceeds 40 wt %, phase separation may occur during the manufacturing process.

When the weight of the graft-modified polypropylene-based resin is less than 1 wt %, physical bonding force is weakened, and it may be difficult to obtain desired tensile strength and flexural strength, and when the weight of the graft-modified polypropylene-based resin exceeds 5 wt %, it may be difficult to implement properties required for vehicle interior materials.

When the content of the fiber filler is less than 15 wt %, strength, elastic modulus, and heat distortion temperature may be reduced, and when the content of the fiber filler exceeds 25 wt %, formability and compatibility may be reduced.

The eco-friendly polypropylene composition may substantially not include a rubber elastomer which is distinguished from ethylene-propylene copolymers, it may include less than 0.01 wt % of the rubber elastomer, or it may include the rubber elastomer in an amount below a detection limit. The rubber elastomer may be, for example, ethylene-octene rubber (EOR), ethylene-butene rubber (EBR), or the like.

The composite may take the form of a masterbatch, solid chips, pellets, or the like, including the wood flour and the low molecular weight hydrocarbon-based material.

The content of the wood flour may be 60 wt % to 80 wt %, and particularly 65 wt % to 78 wt %, with respect to 100 wt % of the composite. The composite may also include the low molecular weight hydrocarbon-based material and inorganic substances.

The content of the low molecular weight hydrocarbon-based material may be 15 wt % to 25 wt %, and the content of the inorganic substances may be 3 wt % to 15 wt %, with respect to 100 wt % of the composite. By having these ranges, good compatibility between the composite including the wood flour and a polypropylene-based material may be achieved, and phase separation may be minimized.

The low molecular weight hydrocarbon-based material may be, for example, a linear aliphatic compound, C20 to C35 paraffin wax, or C31 hentriacontane. The weight-average molecular weight (Mw) of the low molecular weight hydrocarbon-based material may be 500 or less.

The highly crystalline polypropylene-based resin may have crystallinity of 55% or more, and particularly 60% to 85%, compared to general polypropylene resins.

The highly crystalline polypropylene-based resin may include a first polypropylene-based resin having an isotactic pentad fraction of 96% or more by 13C-NMR, and it may optionally include a second polypropylene-based resin including a propylene-ethylene copolymer. The isotactic pentad fraction of the second polypropylene-based resin may be 99% or less.

Here, the isotactic pentad fraction may indicate the ratio of isotactic chains in pentad units in molecular chains measured using 13C-NMR.

The content of the first polypropylene-based resin may be 20 wt % or more, and particularly 25 wt % to 35 wt %, with respect to the total weight of the composition. By having this range, the highly crystalline polypropylene-based resin may be harmonized with the composite including the wood flour, and it may contribute to implementation of properties required for vehicle interior materials.

The first polypropylene-based resin may have a melt index of 30 g/min to 70 g/min at a temperature of 230° C. and a load of 2.16 kg according to ISO 1133-1.

When the highly crystalline polypropylene-based resin includes the second polypropylene-based resin, the content of the second polypropylene-based resin may be 5 wt % to 15 wt % with respect to the total weight of the composition.

The second polypropylene-based resin may have an ethylene content of 5 wt % to 15 wt %.

The graft-modified polypropylene-based resin may, for example, have a polar group introduced into side chains with an acid, or the like, and it may be graft-modified with a material selected from the group consisting of maleic anhydride, acrylic acid, methacrylic acid, and combinations thereof so as to have 1 mol % to 2 mol % of the polar group.

The fiber filler may have a length of 3 mm to 10 mm and an average diameter of 4 μm to 20 μm. By having such a length and diameter, strength and heat resistance may be secured, and deterioration in formability may be minimized.

The fiber filler may include a fiber selected from the group consisting of glass fiber, carbon fiber, metal oxide fiber, and combinations thereof, and, for example, may include glass fiber.

The eco-friendly polypropylene composition may optionally further include an ultraviolet stabilizer, a colorant, and the like, and it may include a hindered amine light stabilizer (HALS), an azo-based or phthalocyanine-based pigment, and the like, and the summed weight of the ultraviolet stabilizer and the colorant may be 0.2 wt % to 2 wt % with respect to the total weight of the composition.

The eco-friendly polypropylene composition may have tensile strength of 26 MPa to 35 MPa according to ISO 725, flexural strength of 41 MPa to 55 MPa according to ISO 178, a flexural modulus of 2450 MPa to 3500 MPa according to ISO 178, and an IZOD impact strength of 4.0 J/m to 5.5 J/m according to ISO 180.

In addition, the heat distortion temperature of the eco-friendly polypropylene composition according to ISO 75 may be 107° C. to 140° C.

The tensile strength, flexural modulus, and IZOD impact strength may be measured at room temperature (23° C.).

When the eco-friendly polypropylene composition satisfies these properties, the eco-friendly polypropylene composition may be easily applied to vehicle interior materials, and it may ensure reliability and a long lifespan.

Hereinafter, embodiments of the present invention will be described in more detail through the following Examples and Comparative Examples. The following Examples and Comparative Examples serve merely to exemplarily describe embodiments of the present invention and are not intended to limit the scope and spirit of the embodiments of the invention.

### Examples and Comparative Examples

The following components were kneaded using a twin screw extruder in weight ratios as set forth in Tables 1 and 2 below. Here, a composite including wood flour and resin components were melted through a main feeder, fillers were input through a side feeder, and these components were extruded at 190° C. in a length/diameter ratio (L/D) of 36/1, and then pellets were manufactured.
1) Wood flour MB: A master batch including wood flour, a low molecular weight hydrocarbon and inorganic substances mixed in a weight ratio of 7:2:1 was provided. Hentriacontane (C31H64) was used as the low molecular weight hydrocarbon.
2) PP-1: Highly crystalline polypropylene with an isotactic pentad fraction of 96% was provided.
3) PP-2: A highly crystalline ethylene-propylene copolymer with crystallinity of 65% was provided.
4) PP-3: An ethylene-propylene copolymer with an ethylene content of 7 wt % and crystallinity of 50% or less was provided.
5) Glass fiber: Glass fiber having a length of 3 mm to 10 mm and a diameter of 4 μm to 20 μm was provided.
6) Glass wool: Sheet-type glass wool was provided.
7) Talc powder: Talc powder having an average particle size of 5 μm was provided.
8) EBR: Ethylene-butylene rubber was provided.
9) EOR: Ethylene-octene rubber was provided.
10) Slip agent: A mixture of polydimethylsiloxane and oleamide mixed in a weight ratio of 1:1 was prepared.
11) Compatibilizer: Polypropylene in which 2 mol % was graft-modified with maleic anhydride was provided.
12) Stabilizer, colorant: A hindered amine light stabilizer (HALS) and a general colorant were provided.

TABLE 1

| | | | | | Comp. | Comp. | Comp. |
|---|---|---|---|---|---|---|---|
| Category | Ex. 1 | Ex. 2 | Ex. 3 | Ex. 4 | example 1 | example 2 | example 3 |
| Wood | 40 | 40 | 40 | 40 | 40 | 40 | 40 |
| flour MB | | | | | | | |
| PP-1 | 36 | 26 | 41 | 31 | 56 | | |
| PP-2 | | 10 | | 10 | | 36 | |
| PP-3 | | | | | | | 36 |
| Glass fiber | 20 | 20 | 15 | 15 | | | |
| Glass wool | | | | | | | |
| Talc | | | | | | 20 | 20 |
| powder | | | | | | | |
| EBR | | | | | | | |
| EOR | | | | | | | |
| Slip agent | | | | | | | |
| Com- | 3 | 3 | 3 | 3 | 3 | 3 | 3 |
| patibilizer | | | | | | | |
| Stabilizer | 1 | 1 | 1 | 1 | 1 | 1 | 1 |
| Colorant | | | | | | | |

Unit: wt %

TABLE 2

| | Comp. | Comp. | Comp. | Comp. | Comp. | Comp. |
|---|---|---|---|---|---|---|
| Category | example 4 | example 5 | example 6 | example 7 | example 8 | example 9 |
| Wood flour MB | 40 | 40 | 40 | 40 | 40 | 40 |
| PP-1 | 39 | 36 | 36 | 35.8 | 31 | 31 |
| PP-2 | | | | | | |
| PP-3 | | | | | | |
| Glass fiber | 20 | | | | | |
| Glass wool | | 20 | | | | |
| Talc powder | | | 20 | 20 | 20 | 20 |
| EBR | | | | | 5 | |
| EOR | | | | | | 5 |
| Slip agent | | | | 0.2 | | |
| Compatibilizer | | 3 | 3 | 3 | 3 | 3 |
| Stabilizer | 1 | 1 | 1 | 1 | 1 | 1 |
| Colorant | | | | | | |

Unit: wt %

### Test Example—Measurement of Properties Required for Vehicle Interior Materials

The pellets obtained in the above Examples and Comparative Examples were injected through a 130 ton electric injection machine manufactured by Woojin Plaimm, and specimens were prepared by setting an injection temperature of 180° C. to 190° C. and an injection pressure of 60 MPa in the order from a feeding hopper to a nozzle.

The obtained specimens were evaluated through methods and standards below, and results thereof are set forth in Tables 3 and 4.
1) Melt index (MI): MI was measured at a temperature of 230° C. and a load of 2.16 kg according to ISO 1133-1.
2) Tensile strength: Tensile strength of a specimen having a thickness of 3.2 mm was measured at a crosshead speed of 50 mm/min according to ISO 725.
3) Flexural strength and flexural modulus: Flexural strength and flexural modulus of a specimen having a size of 80 mm*10 mm*4 mm was measured with a span length of 64 mm at a speed of 2 mm/min according to ISO 178.
4) IZOD impact strength at room temperature (23° C.): After forming a notch on a specimen having a size of 80 mm*10 mm*4 mm, IZOD impact strength of the specimen was measured according to ISO 180.
5) Heat distortion temperature (HDT): Heat distortion temperature of a specimen having a size of 80 mm*10 mm*4 mm was measured flatwise at a stress of 0.45 MPa according to ISO 75.

TABLE 3

| | Required | | | | | | | |
|---|---|---|---|---|---|---|---|---|
| | character- | | | | | Comp. | Comp. | Comp. |
| Category | istic unit | Ex. 1 | Ex. 2 | Ex. 3 | Ex. 4 | ex. 1 | ex. 2 | ex. 3 |
| MI | 8 g/10 min | 10.3 | 12.2 | 13.2 | 13.9 | 12.8 | 15.3 | 6.7 |
| | or more | | | | | | | |
| Tensile | 26 MPa or | 28.4 | 28 | 27.4 | 27.8 | 21 | 26.1 | 23.2 |
| strength | more | | | | | | | |
| Flexural | 41 MPa or | 47.6 | 49.7 | 43.5 | 42.9 | 31 | 41.5 | 37 |
| strength | more | | | | | | | |
| Flexural | 2450 MPa or | 2910 | 2880 | 2630 | 2570 | 1450 | 2640 | 2580 |
| modulus | more | | | | | | | |
| IZOD | 4.0 J/m or | 4.5 | 4.3 | 4.2 | 4.1 | 4.2 | 3.6 | 3.9 |
| impact | more | | | | | | | |
| strength | | | | | | | | |
| Heat | 107° C. or | 128 | 128 | 123 | 122 | 106 | 120 | 119 |
| distortion | higher | | | | | | | |
| temperature | | | | | | | | |

TABLE 4

| | Required | | | | | | |
|---|---|---|---|---|---|---|---|
| | character- | Comp. | Comp. | Comp. | Comp. | Comp. | Comp. |
| Category | istic unit | ex. 4 | ex. 5 | ex. 6 | ex. 7 | ex. 8 | ex. 9 |
| MI | 8 g/10 min | 11.2 | 8.8 | 6.9 | 7.7 | 6.4 | 6.1 |
| | or more | | | | | | |
| Tensile | 26 MPa or | 24.3 | 19.5 | 26.7 | 26.1 | 25.8 | 25.4 |
| strength | more | | | | | | |
| Flexural | 41 MPa or | 40.2 | 36.7 | 49 | 47.8 | 46.2 | 45 |
| strength | more | | | | | | |
| Flexural | 2450 MPa or | 2730 | 2320 | 2840 | 2570 | 2610 | 2530 |
| modulus | more | | | | | | |
| IZOD | 4.0 J/m or | 4.2 | 2.8 | 3 | 3.2 | 3.2 | 3.4 |
| impact | more | | | | | | |
| strength | | | | | | | |
| Heat | 107° C. or | 124 | 111 | 126 | 122 | 123 | 122 |
| distortion | more | | | | | | |
| temperature | | | | | | | |

Referring to Tables 3 and 4, the pellets according to Comparative Example 1 include no fiber filler, and thus exhibited low strength and heat distortion temperature.

The pellets according to Comparative Examples 2, 3, 6, 7, 8, and 9 include talc power as a filler, and thus exhibited low flexural strength, low impact strength, or poor formability.

The pellets according to Comparative Example 4 include no compatibilizer, and thus exhibited poor bending-related characteristics.

The pellets according to Comparative Example 5 use sheet-type glass wool as a filler, and thus exhibited low strength, low bending-related characteristics, and low impact strength.

It was confirmed that the pellets according to Examples, in which the wood flour MB, the highly crystalline polypropylene, the fiber filler, and the compatibilizer are all included in appropriate weights, satisfied all characteristics required for vehicle interior materials.

As is apparent from the above description, an eco-friendly polypropylene composition according to embodiments of the present invention allows hydrophobic polypropylene and hydrophilic wood flour to be combined, and it may strengthen physical bonding force therebetween so as to minimize phase separation and to implement properties required for vehicle interior materials. In addition, even after the eco-friendly polypropylene composition was manufactured as a molded product, the molded product may be reprocessed and recycled through pulverization, and thus, a carbon reduction effect may be expected.

The effects of embodiments of the present invention are not limited to the above-mentioned effects. The effects of embodiments of the present invention should be understood to include all effects that may be inferred from the above description.

The embodiments of the invention have been described in detail with reference to preferred embodiments thereof. However, it will be appreciated by those skilled in the art that changes may be made in these embodiments without departing from the principles and spirit of the embodiments of the invention, the scope of which is defined in the appended claims and their equivalents.

What is claimed is:

1. A polypropylene composition comprising:
a composite comprising wood flour and a low molecular weight hydrocarbon-based material;
a highly crystalline polypropylene-based resin;
a graft-modified polypropylene-based resin; and
a fiber filler.

2. The composition of claim 1, wherein the composition comprises:
35 wt % to 45 wt % of the composite;
30 wt % to 40 wt % of the highly crystalline polypropylene-based resin;
1 wt % to 5 wt % of the graft-modified polypropylene-based resin; and
15 wt % to 25 wt % of the fiber filler.

3. The composition of claim 1, wherein a content of the wood flour is 60 wt % to 80 wt % with respect to 100 wt % of the composite.

4. The composition of claim 1, wherein a weight-average molecular weight of the low molecular weight hydrocarbon-based material is 500 or less.

5. The composition of claim 1, wherein the highly crystalline polypropylene-based resin comprises a first polypropylene-based resin having an isotactic pentad fraction of 96% or more by 13C-NMR.

6. The composition of claim 5, wherein the highly crystalline polypropylene-based resin further comprises a second polypropylene-based resin comprising a propylene-ethylene copolymer.

7. The composition of claim 5, wherein a content of the first polypropylene-based resin is 20 wt % or more with respect to a total weight of the composition.

8. The composition of claim 5, wherein a melt index of the first polypropylene-based resin is 30 g/min to 70 g/min at a temperature of 230° C. and a load of 2.16 kg.

9. The composition of claim 1, wherein the graft-modified polypropylene-based resin is configured such that 1 mol % to 2 mol % thereof is graft-modified with a material selected from the group consisting of maleic anhydride, acrylic acid, methacrylic acid, and combinations thereof.

10. The composition of claim 1, wherein the fiber filler has a length of 3 mm to 10 mm and an average diameter of 4 μm to 20 μm.

11. The composition of claim 1, wherein the fiber filler comprises a fiber selected from the group consisting of glass fiber, carbon fiber, metal oxide fiber, and combinations thereof.

12. The composition of claim 1, wherein the composition has:
a tensile strength of 26 MPa or more according to ISO 725;
a flexural modulus of 2450 MPa or more according to ISO 178; and
an IZOD impact strength of 4.0 J/m or more according to ISO 180.

13. A vehicle comprising:
a vehicle body defining a vehicle interior therein; and
a vehicle interior material disposed in the vehicle interior, the vehicle interior material comprising a polypropylene composition, the composition comprising:
a composite comprising wood flour and a low molecular weight hydrocarbon-based material;
a highly crystalline polypropylene-based resin;
a graft-modified polypropylene-based resin; and
a fiber filler.

14. The vehicle of claim 13, wherein the composition comprises:
35 wt % to 45 wt % of the composite;
30 wt % to 40 wt % of the highly crystalline polypropylene-based resin;
1 wt % to 5 wt % of the graft-modified polypropylene-based resin; and
15 wt % to 25 wt % of the fiber filler.

15. The vehicle of claim 13, wherein:
a content of the wood flour is 60 wt % to 80 wt % with respect to 100 wt % of the composite;
a weight-average molecular weight of the low molecular weight hydrocarbon-based material is 500 or less;
the highly crystalline polypropylene-based resin comprises a polypropylene-based resin having an isotactic pentad fraction of 96% or more by 13C-NMR; and
the fiber filler has a length of 3 mm to 10 mm and an average diameter of 4 μm to 20 μm.

16. A polypropylene composition comprising:
35 wt % to 45 wt % of a composite comprising wood flour and a low molecular weight hydrocarbon-based material;
30 wt % to 40 wt % of a highly crystalline polypropylene-based resin;
1 wt % to 5 wt % of a graft-modified polypropylene-based resin; and
15 wt % to 25 wt % of a fiber filler;
wherein the composition has a tensile strength of 26 MPa or more according to ISO 725;
wherein the composition has a flexural modulus of 2450 MPa or more according to ISO 178; and
wherein the composition has an IZOD impact strength of 4.0 J/m or more according to ISO 180.

17. The composition of claim 16, wherein a content of the wood flour is 60 wt % to 80 wt % with respect to 100 wt % of the composite.

18. The composition of claim 16, wherein a weight-average molecular weight of the low molecular weight hydrocarbon-based material is 500 or less.

19. The composition of claim 16, wherein the highly crystalline polypropylene-based resin comprises a first polypropylene-based resin having an isotactic pentad fraction of 96% or more by 13C-NMR.

20. The composition of claim 16, wherein the fiber filler has a length of 3 mm to 10 mm and an average diameter of 4 μm to 20 μm.
